(19) United States
(12) Patent Application Publication
(10) Pub. No.: US 2009/0238982 A1
(43) Pub. Date: Sep. 24, 2009

(54) REINFORCEMENT OF GLASS-CERAMIC OR GLASS PLATES AND REINFORCED PLATES

(76) Inventors: Frederic Henri Florent, Samoreau (FR); David Henry, Morigny Champigny (FR)

Correspondence Address: CORNING INCORPORATED, SP-TI-3-1, CORNING, NY, 14831, US

(21) Appl. No.: 12/473,792

(22) Filed: May 28, 2009

Related U.S. Application Data
(63) Continuation of application No. 11/079,358, filed on Mar. 11, 2005, now abandoned.
(60) Provisional application No. 60/635,057, filed on Dec. 10, 2004.

(30) Foreign Application Priority Data
Mar. 26, 2004 (FR) 0403125

(51) Int. Cl. B05D 5/00

(52) U.S. Cl. 427/387; 427/384

(57) ABSTRACT

Disclosed in the present application include: (i) a method of reinforcing plates, having two approximately parallel main sides, of a glass-ceramic or a glass, said method comprising fixing at least one layer comprising at least one (co)polymer which is resistant to high temperature onto at least one part of the surface of at least one of their two main sides; as well as (ii) reinforced plates of this type.

### CROSS REFERENCE TO RELATED APPLICATION

This application is a continuation and claims priority to U.S. patent application Ser. No. 11/079,358 filed Mar. 11, 2005, and also claims the priority benefit of European Application No. EP0403125 filed in France Mar. 26, 2004, and U.S. Provisional Patent Application 60/635,057 filed Dec. 10, 2004.

### FIELD OF THE INVENTION

The present invention relates to glass-ceramic or glass plates. More particularly, the present invention relates to glass-ceramic and glass plates bearing a coating. The coating reinforces the mechanical strength of the plate. The present invention is useful, for example, in the production of cooktop plates.

### BACKGROUND OF THE INVENTION

An aim of the present invention is:
a method of reinforcing plates, of glass-ceramic or glass; as well as
reinforced plates of this type.

The method of the invention is a method of treating the plates in question, which improves the mechanical properties of said plates.

This type of plates—of glass-ceramic or glass (glass or toughened glass)—is more and more employed these days, notably as a heating plate, more particularly a cook-top, and a fireplace window plate.

The fragility of such plates, which is all the more critical as the dimensions of their main sides increase, causes problems, both during their manufacture, their storage, their transport, as well as their use. The following has been proposed in order to obtain more solid plates:
acting during the implementation of the method of their manufacture: e.g. by manufacturing them from an intrinsically more resistant material (β-quartz) and/or by implementing said method of manufacture, while at the same time taking care about the absence of any fault, and/or by manufacturing them of greater thickness; and/or
adding steps to said method: e.g. a step of polishing the plates obtained, in order to remove any marks on their main surfaces or a step of texturing the back face of said plates, in order to generate splinters thereon, with the aid of rollers.

Furthermore, without any reference to the technical problem of the fragility of these plates, description has been made of ones which are more or less transparent, with a colored coating (paint) fixed to their lower side; said coating being thus intended to be seen through their thickness. Such plates, which are decorated on their lower side, have notably been described in patent documents EP-A-277 075, EP-A-1 267 593, EP-A-861 014, US-A-2002/0 084 263, US-A-2002/0 019 864, FR-A-2 838 429, and are also described in a co-pending patent application, filed by the Applicant on the same day as the present application.

### SUMMARY OF THE INVENTION

According to a first aspect of the present invention, it is provided a method for reinforcing a glass or glass-ceramic plate having two approximately parallel main sides, of a glass-ceramic or a glass, characterized in that it comprises fixing at least one layer comprising at least one (co)polymer which is resistant to high temperature onto at least one part of the surface of at least one of said two main sides.

In a preferred embodiment of the process of the present invention, the at least one (co)polymer is based on polysiloxane resin.

According to another embodiment of the present invention, it is provided a glass-ceramic or glass plate, comprising a base substrate, of glass-ceramic or glass, in the form of a plate having two approximately parallel main sides, and at least one layer comprising at least one (co)polymer which is resistant to high temperature, or a porous, silica-based inorganic matrix, which is fixed to at least one of said two sides. Preferably, said base substrate, of glass-ceramic or glass, has a thickness of less than 4 mm. Preferably, at least one layer of coating comprising polysiloxane based resin having a thickness between 1-100 μm is fixed to at least one main side of the plate.

### DETAILED DESCRIPTION OF THE INVENTION

In such a context, said Applicant at present proposes a novel method of reinforcing plates of glass-ceramic or glass, this novel method being particularly interesting in that it enables, on the one hand, the efficient reinforcement of actual plates, such as those that exist hitherto; and on the other hand, an efficient reinforcement of plates which are not of value to date due to their intrinsic fragility, due to their low thickness and/or their poor quality.

Said novel method constitutes the first object of the present invention; reinforced plates (of increased value, according to the invention, due to said reinforcement) constitutes the second one.

The method of reinforcement of the invention aims to reinforce:
plates (having two approximately parallel main sides): i.e. full elements which have two approximately parallel main sides (of a lower thickness with regard to the surface of said main sides);
of a glass-ceramic or a glass: the material which constitutes the plates in question can be glass-ceramic or glass. The term “glass” is generic. It corresponds to glass and toughened glass (by chemical or heat toughening).

Said method of reinforcement comprises fixing at least one layer comprising at least one (co)polymer which is resistant to high temperature onto at least one part of the surface of at least one of said two main sides of the plate in question.

One of said two sides (said two sides) may be concerned, in whole or in part. It is understood that the intensity of the reinforcement obtained be linked to the surface of intervention of the reinforcement layer(s).

The plates can be reinforced on their two main sides but advantageously they are so only on one of said two sides, very generally the one which is intended to constitute, during the use of said plates, their lower side (or reverse side or bottom side).

The method of reinforcement of the invention thus makes use, in an entirely original manner, of at least one layer comprising at least one (co)polymer which is resistant to high temperature as reinforcement layer (more often as reinforcement under-layer). It has in fact been discovered, in accordance with the invention, in an entirely unexpected manner, that such an at least one layer comprising at least one (co)polymer which is resistant to high temperature is suited for reinforcing the plate to which it is fixed, is suited for reinforcing said plate up to its degradation. Entirely unexpectedly, the layers of this type proved to be efficient, as a reinforcement, and remain so as long as they are not totally degraded.

According to the invention, the use is thus proposed of said at least one layer comprising at least one (co)polymer which is resistant to high temperature as a mechanical reinforcement of the plates in question. This is a new use, which is in no way suggested by the use according to prior art of such layers as a decorative coating.

Said at least one reinforcement layer is based on an organic binder—polymer, copolymer, a mixture of at least two polymers, of at least two copolymers, of at least one polymer and at least one copolymer—resistant to high temperature, i.e. having a degradation temperature higher than 400° C. (generally of between 400 and 500° C.). Said binder can resist per se or can resist in undergoing physical changes (cross-linking, even pyrolysis: see later on). This resistance to high temperatures is required for the reinforcement layer insofar as it is sought that the effect of reinforcement is exerted during the use of the plates, under conditions of temperature which are more or less severe.

Said at least one reinforcement layer according to the invention obviously comprises said at least one (co)polymer which is resistant to high temperature in a significant amount, which is effective as regards the reinforcement action sought after. Said at least one layer is in fact based on said at least one (co)polymer which is resistant to high temperature.

Said at least one reinforcement layer is in general essentially constituted of said at least one (co)polymer which is resistant to high temperature, which contains or not inorganic fillers (see later on). Nevertheless, it will not be excluded that at least one other compound, e.g. a filling auxiliary (of diluent type), intended to disappear, be incorporated in a mixture with said at least one (co)polymer which is resistant to high temperature (which is suited to exert the effect sought after and to exert it when subjected to high temperatures). The presence, which is temporary or not, of such another compound, through its nature and/or its quality, must not harm the effect sought after significantly.

The nature of said at least one layer comprising at least one (co)polymer which is resistant to high temperature is specified below in the present text, in a totally non-limiting way.

As regards the operation of fixing said at least one layer to the glass-ceramic or to the glass constituting the plate to be reinforced, this does not pose any particular problem. In general, it comprises depositing said at least one layer, optionally followed by heat treating said at least one deposited layer.

The depositing can be carried out by any adapted technique, notably adapted to the viscosity of said at least one layer.

Notably, it can be a deposition with a brush, a deposition with a blade, a deposition by spraying, an electrostatic deposition, a deposition by immersion, a curtain deposition, or a deposit by screen printing. Said at least one layer is advantageously deposited by a deposition with a blade, or by screen printing. It is very advantageously implemented by screen printing.

The deposition is advantageously implemented so as to deposit a single layer.

The eventual heat treatment can intervene in order to ensure a drying of the at least one layer deposited, even a real heat treatment of it. Such a heat treatment can physically transform said at least one deposited layer. Such a physical transformation can be made before any use of the plate in question, or can result from the use of said plate. In any case, the transformation must not nullify the effect of reinforcement ensured, and must not destroy said at least one layer deposited.

The nature of said at least one layer comprising at least one (co)polymer which is resistant to high temperature is now specified in a totally non-limiting way.

Said at least one layer, advantageously said layer, is advantageously based on a polyimide, polyamide, polyfluorinated and/or polysiloxane resin. Said resin can be based on a single resin of one of the types above, on a mixture of several resins of one of the types above, on a mixture of resins of at least two of the types above. Advantageously, it is a polyimide or polysiloxane resin, very advantageously a cross-linkable polysiloxane resin.

Polysiloxane resins are particularly preferred, in that they are colorless and can therefore be used colored with the color desired (i.e. containing fillers which confer said desired color to them); and in that they exist cross-linkable, and can therefore be suitable as a reinforcing layer:
per se;
physically transformed: cross-linked;
further transformed physically: pyrolyzed.

Said pyrolyzed resins are not in fact totally consumed, but keep their silicon-based framework. They evolve from organic to inorganic and keep, in any case, an inorganic skeleton which can exert the action of reinforcement sought after.

Polysiloxane resins which are recommended for the purposes of the invention have, advantageously, phenyl, methyl, ethyl, propyl and vinyl moieties in their formula, very advantageously phenyl and/or methyl moieties. They are preferably selected from:
polydimethylsiloxanes,
polydiphenylsiloxanes,
phenylmethylsiloxane polymers, and
dimethylsiloxane-diphenylsiloxane copolymers.

Whatever their exact nature be, they are cross-linkable, in general by virtue of the presence of SiOH and/or SiOMe groups in their formula. Such groups generally intervene up to 1 to 6% by weight of their total weight.

Said cross-linkable polysiloxane resins generally have a weight average molecular weight (Mw) of between 2,000 and 300,000 Daltons.

It can be indicated in a totally non-limiting manner that the Dow Corning® 804, 805, 806, 808, 840, 249, 409 HS and 418 HS resins, Rhodorsil® 6405 and 6406 resins from Rhodia, Triplus® resin from General Electric Silicone and SILRES® 604 resin from Wacker Chemie GmbH, used alone or in a mixture, are perfectly suitable.

In general, it is recalled at this juncture that the resins which are suitable for the purposes of the invention are resistant to high temperatures, per se or physically transformed. They are thus suitable for resisting notably heating by induction, if they are used under a heating plate which is combined with such a heating means; they can be suitable (notably polysiloxane resins seen above) for resisting radiant heating or halogen heating, if they are used under a heating plate combined with such another means of heating.

Said at least one layer, which is used as a reinforcer in the sense of the invention, advantageously contains an effective amount of inorganic fillers, for ensuring its cohesion and/or its coloration. It is not excluded that such a layer be used which is free from inorganic fillers, notably if its thickness remains low. However, such inorganic fillers are generally incorporated at least in order to mechanically reinforce said at least one (reinforcement) layer. They contribute to the cohesion of said layer, to its attachment to the plate, to fighting against the appearance and the propagation of cracks within it. At least one part of said inorganic fillers advantageously has a lamellar structure for such purposes.

Coloration pigments can be incorporated specifically for the purposes of coloration. Fillers ensuring the cohesion of said at least one layer can also be incorporated for the coloration. The effects of coloration are, within the context of the present invention, accessory. The technical effect of said at least one layer comprising at least one (co)polymer which is resistant to high temperature, that is presently set forth, is that of the mechanical reinforcement of the plate.

The effective amount of inorganic fillers which are advantageously incorporated within the reinforcement layer of the invention (monolayer or multilayer, advantageously monolayer) corresponds in general to a content by volume of 10 to 60%, more generally to a content by volume of 15 to 30% (said contents by volume are based on the total volume of the fillers and of the layer in question).

Said at least one reinforcement layer of the invention generally has a thickness of between 1 and 100 μm, advantageously between 5 and 50 μm.

In an entirely surprising way, the presence of such layers, so thin, has revealed to notably reinforce glass or glass-ceramic plates. This is shown in the Examples below.

The teaching of the co-pending Application is hereby incorporated as regards the color stability of such colored reinforcement layers. Said color stability is acquired if the resin, more particularly silicone, which is used (or the resins which are used in a mixture) is(are) (almost) free from carbon-containing material precursor(s).

Reference is now made to the second object of the present invention, which is plates, which are not interesting per se according to prior art due to their intrinsic fragility, but which are made of value in accordance with the invention due to the original reinforcement which is combined with them.

Novel reinforced plates of the invention consist:
of glass-ceramic or glass plates, comprising a base substrate, of glass-ceramic or glass, in the form of a plate having two approximately parallel main sides, and at least one layer comprising at least one (co)polymer which is resistant to high temperature, or a porous, silica-based inorganic matrix, which is fixed to at least one of said two sides, advantageously to one of said two sides; said base substrate having a thickness of less than 4 mm. Glass-ceramic or glass plates of the prior art (base substrates), which are per se too fragile due to their low thickness (of less than 4 mm), are reinforced by said at least one layer comprising at least one (co)polymer which is resistant to high temperature (as deposited or cross-linked) or by said porous, silica-based inorganic matrix (which can be obtained by pyrolysis of such an at least one layer of silicone resin(s) type);
of glass-ceramic or glass plates, comprising a base substrate, of glass-ceramic or glass, in the form of a plate having two approximately parallel main sides, and at least one layer comprising at least one (co)polymer which is resistant to high temperature, or a porous, silicon-based inorganic matrix, which is fixed to at least one of said two sides, advantageously to one of said two sides; said base substrate having a modulus of rupture of less than 100 MPa; having unacceptable mechanical properties, with reference to their use. Glass-ceramic or glass plates of the prior art (base substrates), which are per se too fragile due to their poor mechanical properties (MOR of less than 100 MPa), are reinforced by said at least one layer comprising at least one (co)polymer which is resistant to high temperature (as deposited or cross-linked) or by said porous, silicon-based inorganic matrix (obtainable by pyrolysis of such an at least one layer of silicone resin(s) type).

It is not excluded to use at least one layer comprising at least one (co)polymer which is resistant to high temperature on one side in the structure of novel plates of the invention (reinforced plates), and a porous, silica-based inorganic matrix on the other side, or at least one layer of (co)polymer(s) which is resistant to high temperature of different nature on each one of said two sides.

The person skilled in the art has already appreciated the interest of the present invention which notably enables putting plates which are hitherto non-performant into value.

The invention is illustrated, in a totally non-limiting way, by the Examples below.

### EXAMPLES

The mechanical resistance of the plates, which are reinforced or not, is evaluated by the classical measurement of the modulus of rupture (MOR). This measurement is made on samples of plate in the shape of a disc of a diameter of 32 mm, the thickness of which is brought to 2.1 mm, by grinding and polishing.

The samples are placed on a three-legged support. When it is reinforced samples, their coated side constitutes their lower side. The filler is applied on their upper side. The contact is ensured by a ball of diameter 1.79 mm. The rate of descent of the point of contact is 0.3 mm/minute. The calculation of the MOR is made with the hypothesis of a Poisson coefficient of 0.2.

### Example 1

A cross-linkable polysiloxane resin is prepared by mixing 10 g of Dow Corning® 249 silicone polymer and 10 g of Dow Corning® 840 silicone solution, until a homogeneous mixture be obtained. 7.46 g of muscovite mica, reference Mica-mu, from CMMP (Comptoir des Mineraux and Matières Premières) and 3.73 g of RL60 TiO₂ from Cerdec are introduced into said homogeneous mixture. The filled polysiloxane resin (white) obtained is again mixed carefully.

It is applied with a blade (by doctoring), in a moist film of 60 μm thickness on a 4 mm-thick Keralite® glass-ceramic plate (on one of the main sides of said plate).

The coated glass-ceramic plate is annealed at 200° C. for 45 minutes and then at 300° C. for 45 minutes. The resin applied is then cross-linked.

The modulus of rupture of this reinforced plate is measured, as well as that of the reference Keralite® plate. The results are given in Table I below.

### Example 2

A mixture of polysiloxane resins of Example 1 is prepared according to the same method. This time, it is filled with 8 g of Iriodine® 24 mica from Merck. The homogeneous mixture obtained (red) is applied in the same way on the same type of plate (4 mm-thick Keralite®). The coated glass-ceramic plate is annealed according to the same heating program.

The modulus of rupture of this plate is measured and is given in Table I below.

TABLE I

| Plate tested | Modulus of rupture: MOR (MPa) |
|---|---|
| Reference Plate | 221 ± 34 |
| Plate of Example 1 | 288 ± 41 |
| Plate of Example 2 | 270 ± 91 |

The plates of Examples 1 and 2 were reinforced.

Furthermore, they show a good adhesion of the reinforcement coating to the glass-ceramic, as well as a good cohesion of the coating itself, in line with the application sought after.

Said plates remain reinforced when aged at 400° C. (use conditions as cooking plates combined with an induction heating).

Their coating is furthermore stable in color.

### Example 3

A white coating composition is prepared in the following way:

40 g of Dow Corning® 249 silicone polymer granules are dissolved in 18 g of Exxon Solvesso® 100 solvent from Exxon Mobil Chemical. This dissolution is done with stirring at 80° C.

After cooling, 29.1 g of muscovite mica, 325 mesh (CMMP: Comptoir des Mineraux and Matières Premières) and 14.6 g of RL628 TiO₂ (Ferro Couleurs France S. A.) are added to the solution and are mixed until homogenization. This composition is applied by screen printing (screen: 90 strands/cm) on transparent glass-ceramic substrates (Eurokéra) and is polymerized (cross-linked) for 1 hour at 250° C. for a dry film thickness of about 15 microns.

The modulus of rupture of these reinforced plates (as such, as well as after heat ageing at 400 and 510° C. (i.e. with their pyrolyzed coating)) is measured and compared to that of the reference plate (non-coated). The results are given in Table II below.

TABLE II

| Plate tested | MOR (MPa) |
|---|---|
| Non-coated substrate (14 samples) | 208 ± 71 |
| Substrate with white coating (8 samples) | 243 ± 68 |
| Substrate with white coating aged 400° C./15 h (5 samples) | 271 ± 54 |
| Substrate with white coating aged 510° C./9 h (6 samples) | 259 ± 66 |

The coated plates were reinforced and remain so, even aged under severe conditions. Such plates are perfectly suitable to be used as cooking plates combined with induction heating and with heating with radiant or halogen electric elements.

Furthermore, it is insisted upon the good adhesion of the reinforcement coating to the plate, the good cohesion of said coating and the very low evolution of color of said coating.

1-20. (canceled)

21. A method of reinforcing a plate, having two approximately parallel main sides each having a surface, of a glass-ceramic or a glass, comprising fixing at least one layer comprising at least one (co)polymer which is resistant to high temperature onto at least one part of the surface of at least one of said two main sides, wherein said (co)polymer comprises a polyimide, polyamide, polyfluorinated and/or polysiloxane resin, and said at least one layer has a thickness of between 1 and 100 μm and further comprises inorganic fillers having a content by volume of between 10-60%.

22. The method of reinforcement according to claim 21, wherein the at least one layer is fixed to only one of the two main sides.

23. The method of reinforcement according to claim 21, wherein said fixing comprises depositing said at least one layer comprising at least one (co)polymer which is resistant to high temperature, optionally followed by heat treating said at least one deposited layer at a temperature of at least 200° C.

24. The method of reinforcement according to claim 23, wherein said depositing is carried out by deposition with a brush, by deposition with a blade, by spraying, by electrostatic deposition, by immersion, by curtain deposition, or by screen printing.

25. The method of reinforcement according to claim 21, wherein said (co)polymer comprises polysiloxane resin.

26. The method of reinforcement according to claim 25, wherein said (co)polymer comprises a cross-linked polysiloxane resin.

27. The method of reinforcement according to claim 21, wherein said at least one layer contains an effective amount of inorganic fillers, for ensuring cohesion and coloration of the at least one layer.

28. The method of reinforcement according to claim 27, wherein at least part of said inorganic fillers has a lamellar structure.

29. The method of reinforcement according to claim 21, wherein the inorganic fillers have a content by volume of between 15-30%.

30. The method of reinforcement according to claim 21, wherein said at least one layer has a thickness of between 5 and 50 μm.

31. A method of reinforcement according to claim 26, wherein the MOR of the plate having the at least one layer of (co)polymer is increased by about 16 to 25% compared to a plate without a surface coating.

32. A method of reinforcement according to claim 31, wherein the MOR of the plate having the at least one layer of (co)polymer is increased by about 16 to 30% compared to a plate without a surface coating.
